(19) United States
(12) Patent Application Publication
(10) Pub. No.: US 2010/0313158 A1
(43) Pub. Date: Dec. 9, 2010

(54) METHOD FOR EDITING DATA IN MOBILE TERMINAL AND MOBILE TERMINAL USING THE SAME

(75) Inventors: Min Jin Lee, Seoul (KR); Hyoung Mi Kim, Seoul (KR); Il Kook Kim, Seoul (KR); Young Hoon Lee, Seoul (KR); Jin A. Chang, Seoul (KR); Seong Ki Sohn, Seoul (KR); Hyun Bo Choi, Seoul (KR); Jae Yeon Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/773,774

(22) Filed: May 4, 2010

(30) Foreign Application Priority Data
Jun. 8, 2009 (KR) 10-2009-0050281
Dec. 1, 2009 (KR) 10-2009-0117961

(51) Int. Cl. G06F 3/048

(52) U.S. Cl. 715/769; 715/772; 715/764

(57) ABSTRACT

A method for editing data in a mobile terminal configured to conveniently change a symbol and a mobile terminal using the method for editing data are disclosed, wherein the method includes displaying an inputted data on a touch screen, displaying on the touch screen a progress bar including a handler if a progress bar display signal is inputted, generating an undo signal or a redo signal based on a drag direction by touching the handler, and deleting the data in response to the undo signal, or reinstate the data in response to the redo signal.

Pursuant to 35 U.S.C. §119 (a), this application claims the benefit of earlier filing date and right of priority to Korean Patent Application Nos. 10-2009-0050281, filed on Jun. 8, 2009 and 10-2009-0117961, filed on Dec. 1, 2009, the contents of which are hereby incorporated by reference in their entirety.

### BACKGROUND OF THE DISCLOSURE

1. Field

The present disclosure relates to a method for editing data in a mobile terminal configured to conveniently change a symbol and a mobile terminal using the method for editing data.

2. Background

Generally, mobile terminals are portable and have one or more functions of audio and image communication, functions of information input/output and functions of data storage.

As functions of the terminal are diversified, the terminal is implemented as a multimedia player provided with composite functions such as photographing of photos or moving pictures, playback of music or moving picture files, game play, broadcast reception and the like, for example.

To implement the complex functions in the multimedia player, improvement of structural parts and/or software parts of the terminal may be considered in various attempts. For example, the mobile terminal is provided with a user interface environment for a user to conveniently retrieve or select the functions.

In a case a variety of information is transmitted and received using the mobile terminal, there is a risk of important personal information being exposed, such that many attempts have been waged to prevent the leakage of important personal information.

### SUMMARY OF THE DISCLOSURE

In one general aspect of the present disclosure, a method for editing data in a mobile terminal comprises: displaying an inputted data on a touch screen; displaying on the touch screen a progress bar including a handler if a progress bar display signal is inputted; generating an undo signal or a redo signal based on a drag direction by touching the handler; and deleting the data in response to the undo signal, or reinstate the data in response to the redo signal.

In some exemplary embodiments of the present disclosure, the data may be at least one of characters, figures and symbols inputted by a keypad or a soft key.

In some exemplary embodiments of the present disclosure, the undo signal may be a continuous sequential signal generated by a touch and a left hand side drag of the handler.

In some exemplary embodiments of the present disclosure, the redo signal may be a continuous sequential signal generated by a touch and a right hand side drag of the handler.

In some exemplary embodiments of the present disclosure, the step of deleting or reinstating the data may include continuously and sequentially deleting or reinstating the data in response to the undo signal or the redo signal continuously and sequentially generated by a moving distance of the handler moving on the progress bar.

In some exemplary embodiments of the present disclosure, the method may further include deleting the display of the progress bar and changing to a data input mode capable of inputting the data if a data input mode entry signal is inputted.

In some exemplary embodiments of the present disclosure, the step of deleting the data in response to the undo signal or reinstating the data in response to the redo signal may include deleting or reinstating the data based on a data input time sequence or a data position sequence.

In another general aspect of the present disclosure, a mobile terminal comprises: a touch screen configured to display a data; and a controller configured to display a progress bar including the handler on the touch screen if a progress bar display signal is inputted, and to continuously and sequentially delete the data in response to a continuous sequential undo signal or reinstate the data in response to the redo signal if the continuous sequential undo or redo signal is generated.

In still another general aspect of the present disclosure, a method for editing data in a mobile terminal comprises: drawing a data on a touch screen and displaying the data on the touch screen; generating a continuous sequential undo signal to the data; and deleting the drawn data continuously and sequentially in response to the continuous sequential undo signal.

In some exemplary embodiments of the present disclosure, the method may further comprise: generating a continuous sequential redo signal to the undo signal; and continuously and sequentially reinstating the deleted data in response to the continuous sequential redo signal.

In some exemplary embodiments of the present disclosure, the step of generating a continuous sequential undo or redo signal to the data may comprise: displaying a wheel-shaped input media on the touch screen; and generating the continuous undo or redo signal by touching and dragging the wheel-shaped input media.

In some exemplary embodiments of the present disclosure, the step of generating a continuous sequential undo or redo signal to the data may comprise generating the continuous sequential undo or redo signal based on a gesture input for generating the continuous sequential undo or redo signal on the touch screen.

In still further another general aspect of the present disclosure, a motile terminal using a method for editing data comprises: a touch screen configured to draw a data; a controller configured to continuously and sequentially delete or reinstate a drawn data in response to a continuous and sequential undo or redo signal if a data is drawn on the touch screen and the continuous sequential undo or redo signal is generated to the data.

In some exemplary embodiments of the present disclosure, the continuous sequential undo or redo signal to the data may be generated as the wheel-shaped input media is displayed on the touch screen and the wheel-shaped input media is touched and dragged.

In some exemplary embodiments of the present disclosure, the continuous sequential undo or redo signal to the data may be generated by a gesture input for generating the continuous sequential undo or redo signal on the touch screen.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a mobile terminal according to an exemplary embodiment of the present disclosure;

FIG. 2a is a front-view of a mobile terminal according to an example embodiment;

FIG. 2b is a perspective diagram of a backside of the mobile terminal shown in FIG. 2a;

FIGS. 3a and 3b are front views of a mobile terminal for illustrating an operation status of the mobile terminal according to the present disclosure;

FIG. 4 is a flowchart illustrating a method for editing data in a mobile terminal according to a first exemplary embodiment of the present disclosure;

FIG. 5 is a flowchart illustrating a method for editing data in a mobile terminal according to a second exemplary embodiment of the present disclosure;

FIG. 6a˜6d are an image view illustrating a first example of a method for editing data in a mobile terminal according to a first exemplary embodiment of the present disclosure;

FIG. 7a˜7d are an image view illustrating a second example of a method for editing data in a mobile terminal according to the first exemplary embodiment of the present disclosure;

FIG. 8a˜8c an image view illustrating a third example of a method for editing data in a mobile terminal according to the first exemplary embodiment of the present disclosure;

FIG. 9a˜9f are an image view illustrating a fourth example of a method for editing data in a mobile terminal according to the first exemplary embodiment of the present disclosure;

FIG. 10a˜10e are an image view illustrating a fifth example of a method for editing data in a mobile terminal according to the first exemplary embodiment of the present disclosure;

FIG. 11 is an image view illustrating a first example of a method for editing data in a mobile terminal according to the second exemplary embodiment of the present disclosure; and

FIGS. 12a˜12c are image views illustrating a second example of a method for editing data in a mobile terminal according to the second exemplary embodiment of the present disclosure.

### DETAILED DESCRIPTION

The suffixes ‘module’, ‘unit’ and ‘part’ may be used for elements in order to facilitate the disclosure. Significant meanings or roles may not be given to the suffixes themselves and it is understood that the ‘module’, ‘unit’ and ‘part’ may be used together or interchangeably.

Embodiments of the present disclosure may be applicable to various types of terminals. Examples of such terminals may include mobile terminals as well as stationary terminals, such as mobile phones, user equipment, smart phones, DTV, computers, digital broadcast terminals, personal digital assistants, portable multimedia players (PMP) and/or navigators.

A further description may be provided with regard to a mobile terminal, although such teachings may apply equally to other types of terminals such as stationary terminals that include digital TVs and desktop computers, the details of which are well known to the persons in the art.

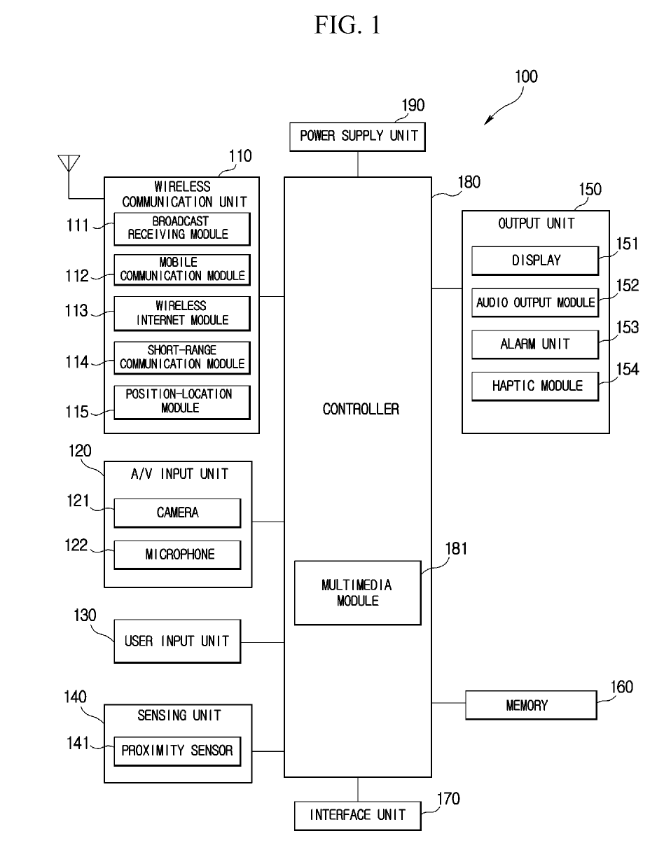

FIG. 1 is a block diagram of a mobile terminal in accordance with an example embodiment. Other embodiments and arrangements may also be provided. FIG. 1 shows a mobile terminal 100 having various components, although other components may also be used. More or less components may alternatively be implemented.

FIG. 1 shows that the mobile terminal 100 includes a wireless communication unit 110, an audio/video (A/V) input unit 120, a user input unit 130, a sensing unit 140, an output unit 150, a memory 160, an interface unit 170, a controller 180 and a power supply unit 190.

The constituent elements shown in FIG. 1 are not essential, such that other mobile terminals may be implemented with fewer elements or more elements than are shown in FIG. 1. Now, the constituent elements will be described in detail.

The wireless communication unit 110 may be configured with several components and/or modules. The wireless communication unit 110 may include a broadcast receiving module 111, a mobile communication module 112, a wireless Internet module 113, a short-range communication module 114 and a position-location module 115. The wireless communication unit 110 may include one or more components that permit wireless communication between the mobile terminal 100 and a wireless communication system or a network within which the mobile terminal 100 is located. In case of non-mobile terminals, the wireless communication unit 110 may be replaced with a wire communication unit. The wireless communication unit 110 and the wire communication unit may be commonly referred to as a communication unit.

The broadcast receiving module 111 may receive a broadcast signal and/or broadcast associated information from an external broadcast managing entity via a broadcast channel. The broadcast channel may include a satellite channel and a terrestrial channel. The broadcast managing entity may refer to a system that transmits a broadcast signal and/or broadcast associated information.

At least two broadcast receiving modules 111 may be provided in the mobile terminal 100 to pursue simultaneous reception of at least two broadcast channels or facilitation of broadcast channel switching.

Examples of broadcast associated information may include information associated with a broadcast channel, a broadcast program, a broadcast service provider, etc. For example, broadcast associated information may include an electronic program guide (EPG) of digital multimedia broadcasting (DMB) and an electronic service guide (ESG) of digital video broadcast-handheld (DVB-H).

The broadcast signal may be a TV broadcast signal, a radio broadcast signal, and/or a data broadcast signal. The broadcast signal may further include a broadcast signal combined with a TV or radio broadcast signal.

The broadcast receiving module 111 may receive broadcast signals transmitted from various types of broadcast systems. As a non-limiting example, the broadcasting systems may include digital multimedia broadcasting-terrestrial (DMB-T), digital multimedia broadcasting-satellite (DMB-S), digital video broadcast-handheld (DVB-H), a data broadcasting system known as media forward link only (MediaFLO®) and integrated services digital broadcast-terrestrial (ISDB-T). The receiving of multicast signals may also be provided. Data received by the broadcast receiving module 111 may be stored in the memory 160, for example.

The mobile communication module 112 may communicate wireless signals with one or more network entities (e.g. a base station or Node-B). The signals may represent audio, video, multimedia, control signaling, and data, etc.

The wireless Internet module 113 may support Internet access for the mobile terminal 100. This wireless Internet module 113 may be internally or externally coupled to the mobile terminal 100. Suitable technologies for wireless Internet may include, but are not limited to, WLAN (Wireless LAN)(Wi-Fi), Wibro (Wireless broadband), Wimax (World Interoperability for Microwave Access), and/or HSDPA (High Speed Downlink Packet Access). The wireless Internet module 113 may be replaced with a wire Internet module in non-mobile terminals. The wireless Internet module 113 and the wire Internet module may be referred to as an Internet module.

The short-range communication module 114 may facilitate short-range communications. Suitable technologies for short-range communication may include, but are not limited to, radio frequency identification (RFID), infrared data association (IrDA), ultra-wideband (UWB), as well as networking technologies such as Bluetooth and ZigBee.

The position-location module 115 may identify or otherwise obtain a location of the mobile terminal 100. The position-location module 115 may be provided using global positioning system (GPS) components that cooperate with associated satellites, network components, and/or combinations thereof.

The position-location module 115 may precisely calculate current 3-dimensional position information based on longitude, latitude and altitude by calculating distance information and precise time information from at least three satellites and then by applying triangulation to the calculated information. Location and time information may be calculated using three satellites, and errors of the calculated location position and time information may then be amended or changed using another satellite. The position-location module 115 may calculate speed information by continuously calculating a real-time current location.

Referring to FIG. 1, the audio/video (A/V) input unit 120 may provide audio or video signal input to the mobile terminal 100. The A/V input unit 120 may include a camera 121 and a microphone 122. The camera 121 may receive and process image frames of still pictures and/or video. The processed image frames of still pictures and/or video may be displayed on a display 151.

The image frames processed by the camera 121 may be stored in the memory 160 or may be transmitted to the outside via the wireless communication unit 110. Two or more cameras may be provided according to use environment.

The microphone 122 may receive an external audio signal while the mobile terminal is in a particular mode, such as a phone call mode, a recording mode and/or a voice recognition mode. The received audio signal may then be processed and converted into digital data.

The mobile terminal 100, and in particular the A/V input unit 120, may include a noise removing algorithm (or noise canceling algorithm) to remove noise generated in the course of receiving the external audio signal. Data generated by the A/V input unit 120 may be stored in the memory 160, utilized by the output unit 150, and/or transmitted via one or more modules of the wireless communication unit 110. Two or more microphones and/or cameras may also be provided.

The user input unit 130 may generate input data responsive to user manipulation of an associated input device or devices. Examples of such devices may include a keypad, a dome switch, a touchpad (e.g., static pressure/capacitance), a jog wheel and/or a jog switch.

The sensing unit 140 may provide status measurements of various aspects of the mobile terminal 100. For example, the sensing unit 140 may detect an open/close status (or state) of the mobile terminal 100, a relative positioning of components (e.g., a display and a keypad) of the mobile terminal 100, a change of position of the mobile terminal 100 or a component of the mobile terminal 100, a presence or absence of user contact with the mobile terminal 100, and/or an orientation or acceleration/deceleration of the mobile terminal 100.

The mobile terminal 100 may be configured as a slide-type mobile terminal. In such a configuration, the sensing unit 140 may sense whether a sliding portion of the mobile terminal 100 is open or closed. The sensing unit 140 may also sense presence or absence of power provided by the power supply unit 190, presence or absence of a coupling or other connection between the interface unit 170 and an external device, etc.

The sensing unit 140 may include a proximity sensor 141.

The output unit 150 may generate an output relevant to a sight sense, an auditory sense, a tactile sense and/or the like. The output unit 150 may include a display 151, an audio output module 152, an alarm unit 153, a haptic module 154 and/or the like.

The display 151 may display (output) information processed by the terminal 100. For example, in case that the terminal is in a call mode, the display 151 may display a user interface (UI) or a graphic user interface (GUI) associated with the call. If the mobile terminal 100 is in a video communication mode or a photograph mode, the display 151 may display a photographed and/or received picture, a UI or a GUI.

The display 151 may include at least one of a liquid crystal display (LCD), a thin film transistor liquid crystal display (TFT LCD), an organic light-emitting diode (OLED), a flexible display, and a 3-dimensional display.

The display 151 may have a transparent or light-transmissive type configuration to enable an external environment to be seen through. This may be called a transparent display. A transparent OLED (TOLED) may be an example of a transparent display. A backside structure of the display 151 may also have the light-transmissive type configuration. In this configuration, a user may see an object located behind the terminal body through the area occupied by the display 151 of the terminal body.

At least two or more displays 151 may also be provided. For example, a plurality of displays may be provided on a single face of the terminal 100 by being built in one body or spaced apart from the single face. Alternatively, each of a plurality of displays may be provided on different faces of the terminal 100.

If the display 151 and a sensor for detecting a touch action (hereinafter a touch sensor) are constructed in a mutual-layered structure (hereinafter a touch screen), the display 151 may be used as an input device as well as an output device. For example, the touch sensor 142 may include a touch film, a touch sheet, a touchpad and/or the like.

The touch sensor 142 may convert a pressure applied to a specific portion of the display 151 or a variation of electrostatic capacity generated from a specific portion of the display 151 to an electric input signal. The touch sensor may detect a pressure of a touch as well as a position and size of the touch.

If a touch input is provided to the touch sensor 142, signal(s) corresponding to the touch input may be transferred to a touch controller. The touch controller may process the signal(s) and then transfer corresponding data to the controller 180. The controller 180 may therefore know which portion of the display 151 is touched.

FIG. 1 shows that the proximity sensor 141 can be provided within the mobile terminal 100 enclosed by the touch-screen or around the touch screen. The proximity sensor 141 may detect a presence or non-presence of an object approaching a prescribed detecting surface or an object existing around the proximity sensor 141 using an electromagnetic field strength or infrared ray without mechanical contact. The proximity sensor 141 may have a longer durability than the contact type sensor and may also have a greater usage than the contact type sensor.

The proximity sensor 141 may include one of a transmissive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and/or the like. If the touch screen is an electrostatic type, the proximity sensor 141 may detect proximity of a pointer using a variation of an electric field according to the proximity of the pointer. In this case, the touch screen (touch sensor) may be classified into the proximity sensor.

An action in which a pointer approaches the touch screen without contacting the touch screen may be called a proximity touch. An action in which a pointer actually touches the touch screen may be called a contact touch. The location of the touch screen proximity-touched by the pointer may be the position of the pointer that vertically opposes the touch screen when the pointer performs the proximity touch.

The proximity sensor 141 may detect a proximity touch and/or a proximity touch pattern (e.g., a proximity touch distance, a proximity touch duration, a proximity touch position, a proximity touch shift state, etc.). Information corresponding to the detected proximity touch action and/or the detected proximity touch pattern may be outputted to the touch screen.

The audio output module 152 may output audio data that is received from the wireless communication unit 110 in a call signal reception mode, a call mode, a recording mode, a voice recognition mode, a broadcast receiving mode and/or the like. The audio output module 152 may output audio data stored in the memory 160. The audio output module 152 may output an audio signal relevant to a function (e.g., a call signal receiving sound, a message receiving sound, etc.) performed by the mobile terminal 100. The audio output module 152 may include a receiver, a speaker, a buzzer and/or the like.

The alarm unit 153 may output a signal for announcing an event occurrence of the mobile terminal 100. An event occurring in the mobile terminal 100 may include one of a call signal reception, a message reception, a key signal input, a touch input and/or the like. The alarm unit 153 may output a signal for announcing an event occurrence by way of vibration or the like as well as a video signal or an audio signal. The video signal may be outputted via the display 151. The audio signal may be outputted via the audio output module 152. The display 151 or the audio output module 152 may be classified as part of the alarm unit 153.

The haptic module 154 may bring about various haptic effects that can be sensed by a user. Vibration is a representative example for the haptic effect brought about by the haptic module 154. Strength and pattern of the vibration generated from the haptic module 154 may be controllable. For example, vibrations differing from each other may be outputted in a manner of being synthesized together or may be sequentially outputted.

The haptic module 154 may generate various haptic effects including a vibration, an effect caused by such a stimulus as a pin array vertically moving against a contact skin surface, a jet power of air via outlet, a suction power of air via inlet, a skim on a skin surface, a contact of an electrode, an electrostatic power and the like, and/or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger, an arm and/or the like. Two or more haptic modules 154 may be provided according to a configuration of the mobile terminal 100.

The memory 160 may store a program for operations of the controller 180. The memory 160 may temporarily store input/output data (e.g., phonebook, message, still picture, moving picture, etc.). The memory 160 may store data of vibration and sound in various patterns outputted in case of a touch input to the touch screen.

The memory 160 may include at least one of a flash memory, a hard disk, a multimedia card micro type memory, a card type memory (e.g., SD memory, XD memory, etc.), a random access memory (RAM), a static random access memory (SRAM), a read-only memory (ROM), an electrically erasable programmable read-only memory, a programmable read-only memory, a magnetic memory, a magnetic disk, an optical disk, and/or the like. The mobile terminal 100 may operate in association with a web storage that performs a storage function of the memory 160 in the Internet.

The interface unit 170 may play a role as a passage to external devices connected to the mobile terminal 100. The interface unit 170 may receive data from an external device. The interface unit 170 may be supplied with a power and then the power may be delivered to elements within the mobile terminal 100. The interface unit 170 may enable data to be transferred to an external device from an inside of the mobile terminal 100. The interface unit 170 may include a wire/wireless headset port, an external charger port, a wire/wireless data port, a memory card port, a port for coupling to a device having an identity module, an audio input/output (I/O) port, a video input/output (I/O) port, an earphone port and/or the like.

The identity module may be a chip or card that stores various kinds of information for authenticating use of the mobile terminal 100. The identify module may include a user identity module (UIM), a subscriber identity module (SIM), a universal subscriber identity module (USIM) and/or the like. A device provided with the above identity module (hereafter an identity device) may be manufactured in the form of a smart card. The identity device may be connected to the mobile terminal 100 via the port.

The interface unit 170 may play a role as a passage for supplying a power to the mobile terminal 100 from a cradle that is connected to the mobile terminal 100. The interface unit 170 may play a role as a passage for delivering various command signals, which are inputted from the cradle by a user, to the mobile terminal 100. Various command signals inputted from the cradle or the power may work as a signal for recognizing that the mobile terminal 100 is correctly loaded in the cradle.

The controller 180 may control overall operations of the mobile terminal 100. For example, the controller 180 may perform control and processing relevant to a voice call, a data communication, a video conference and/or the like. The controller 180 may have a multimedia module 181 for multimedia playback. The multimedia module 181 may be implemented within the controller 180 or may be configured separate from the controller 180.

The controller 180 may perform pattern recognizing processing for recognizing a handwriting input performed on the touch screen as a character an/or recognizing a picture drawing input performed on the touch screen as an image.

The power supply unit 190 may receive an external or internal power and then supply the power required for operations of the respective elements under control of the controller 180.

Embodiments of the present disclosure explained in the following description may be implemented within a recording medium that can be read by a computer or a computer-like device using software, hardware or combination thereof.

According to the hardware implementation, arrangements and embodiments may be implemented using at least one of application specific integrated circuits (ASICs), digital signal processors (DSPs), digital signal processing devices DSPDs), programmable logic devices (PLDs), field programmable gate arrays (FPGAs), processors, controllers, microcontrollers, microprocessors and electrical units for performing other functions. In some cases, embodiments may be implemented by the controller 180.

For a software implementation, arrangements and embodiments described herein may be implemented with separate software modules, such as procedures and functions, each of which may perform one or more of the functions and operations described herein. Software codes may be implemented with a software application written in any suitable programming language and may be stored in memory such as the memory 160, and may be executed by a controller or processor, such as the controller 180.

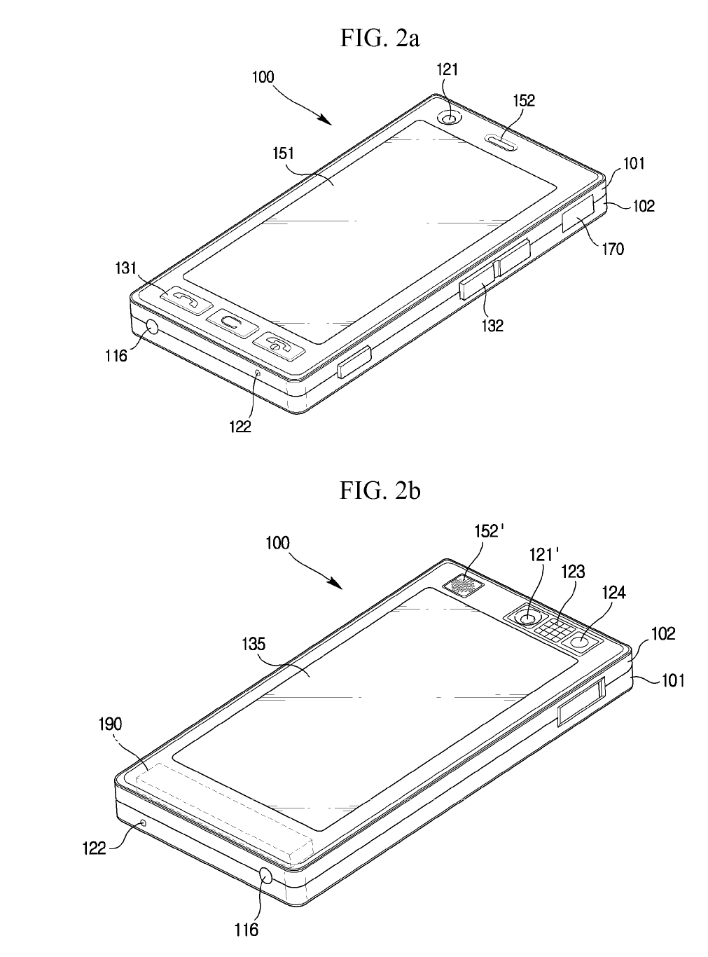

FIG. 2a is a front-view of a mobile terminal according to an example embodiment. Other embodiments, configurations and arrangements may also be provided.

As shown in FIG. 2a, the mobile terminal 100 may include a bar type terminal body. Embodiments of the mobile terminal may be implemented in a variety of different configurations. Examples of such configuration may include a folder-type, a slide-type, a bar-type, a rotational-type, a swing-type and/or combinations thereof.

The body may include a case (casing, housing, cover, etc.) that forms an exterior of the terminal. The case may be divided into a front case 101 and a rear case 102. Various electric/electronic parts may be provided in a space between the front case 101 and the rear case 102. A middle case may be further provided between the front case 101 and the rear case 102.

The cases may be formed by injection molding of synthetic resin or may be formed of metal substance such as stainless steel (STS), titanium (Ti) or the like, for example.

The display 151, the audio output unit 152, the camera 121, user input units 130/131/132, the microphone 122, the interface unit 170 and the like may be provided on the terminal body, and more particularly on the front case 101.

The display 151 may occupy most of a main face of the front case 101. The audio output module 152 and the camera 121 may be provided at an area adjacent to one end portion of the display 151, while the user input unit 131 and the microphone 122 may be provided at another area adjacent to the other end portion of the display 151. The user input unit 132 and the interface unit 170 may be provided on lateral sides of the front and rear cases 101 and 102.

The user input unit 130 may receive a command for controlling an operation of the mobile terminal 100. The user input unit 130 may include a plurality of manipulating units 131 and 132. The manipulating units 131 and 132 may be called a manipulating portion and may adopt any mechanism of a tactile manner that enables a user to perform a manipulation action by experiencing a tactile feeling.

Content inputted by the first manipulating unit 131 or the second manipulating unit 132 may be diversely set. For example, a command such as start, end, scroll and/or the like may be inputted to the first manipulating unit 131. A command for a volume adjustment of sound outputted from the audio output unit 152, a command for switching to a touch recognizing mode of the display 151 or the like may be inputted to the second manipulating unit 132.

FIG. 2b is a perspective diagram of a backside of the mobile terminal shown in FIG. 2a. Other embodiments, configurations and arrangements may also be provided.

As shown in FIG. 2b, a camera 121′ may be additionally provided on a backside of the terminal body, and more particularly on the rear case 102. The camera 121′ may have a photographing direction that is substantially opposite to a photographing direction of the camera 121 (shown in FIG. 2a) and may have pixels differing from pixels of the camera 121.

For example, the camera 121 may have a lower number of pixels to capture and transmit a picture of user face for a video call, while the camera 121′ may have a greater number of pixels for capturing a general subject for photography without transmitting the captured subject. Each of the cameras 121 and 121′ may be installed on the terminal body to be rotated and/or popped up.

A flash 123 and a mirror 124 may be additionally provided adjacent to the camera 121′. The flash 123 may project light toward a subject in case of photographing the subject using the camera 121′. If a user attempts to take a picture of the user (self-photography) using the camera 121′, the mirror 124 may enable the user to view a user's face reflected by the mirror 124.

An additional audio output unit 152′ may be provided on the backside of the terminal body. The additional audio output unit 152′ may implement a stereo function together with the audio output unit 152 shown in FIG. 2A and may be used for implementation of a speakerphone mode in talking over the terminal.

A broadcast signal receiving antenna 116 may be additionally provided at the lateral side of the terminal body as well as an antenna for communication or the like. The antenna 116 may be considered a portion of the broadcast receiving module 111 shown in FIG. 1 and may be retractably provided on the terminal body.

The power supply unit 190 for supplying a power to the mobile terminal 100 may be provided to the terminal body. The power supply unit 190 may be built within the terminal body. Alternatively, the power supply unit 190 may be detachably and attachably connected to the terminal body.

FIG. 2b also shows a touchpad 135 for detecting a touch that is additionally provided on the rear case 102. The touchpad 135 may be configured in a light transmissive type like the display 151. If the display 151 outputs visual information from both faces, the display 151 may recognize visual information via the touchpad 135 as well. The information outputted from both of the faces may be controlled by the touchpad 135. Alternatively, a display may be further provided to the touchpad 135 so that a touch screen may also be provided to the rear case 102.

The touchpad 135 may be activated by interconnecting with the display 151 of the front case 101. The touchpad 135 may be provided in rear of the display 151 in parallel to one another. The touchpad 135 may have a size equal to or smaller than a size of the display 151.

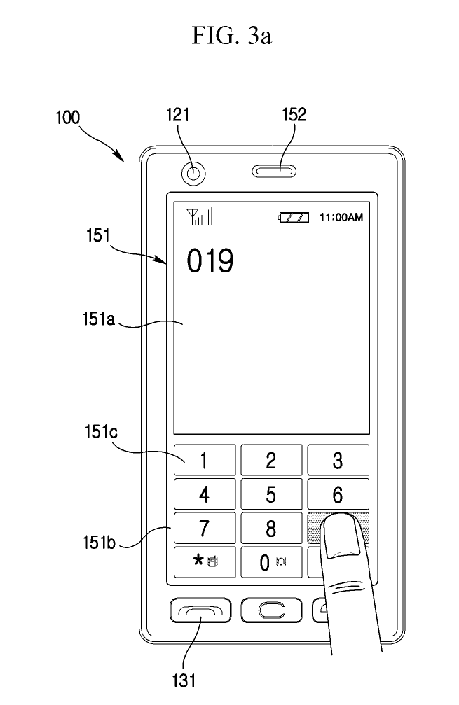

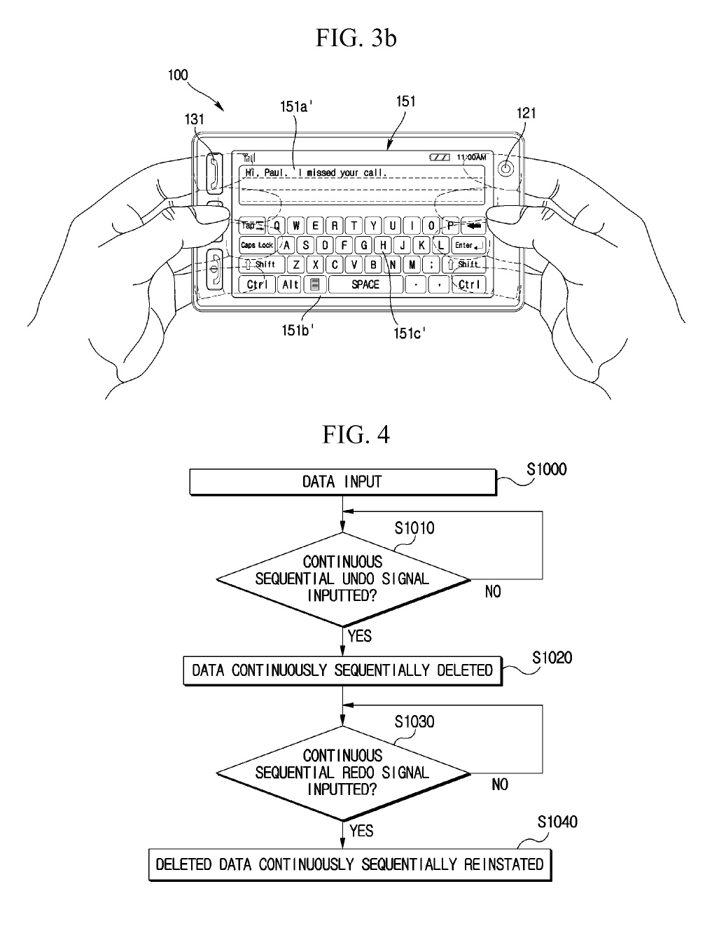

Now, an interconnecting operation method between the display 151 and the touchpad 135 will be illustrated with reference to FIGS. 3a and 3b.

FIGS. 3a and 3b are front views of mobile terminal illustrating an operation status of the mobile terminal according to the present disclosure.

The display 151 may be displayed with various types of visual information, where the information may include texts, numbers, symbols, graphics or icons. In order to input the information, at least of the texts, numbers, symbols, graphics or icons may be displayed in a predetermined arrangement for implementation in the form of a keypad. The keypad is a so-called “soft key”.

FIG. 3a illustrates an input of touch applied to a soft key through a front surface of body of the mobile terminal.

The display 151 may be operated on an entire area or operated by being divided into a plurality of areas. In the case of the latter, the plurality of areas may be so configured as to be inter-connectively operated.

For example, an upper area and a lower area of the display 151 may be respectively displayed with an output window 151a and an input window 151b. Each of the output window 151a and the input window 151b is an area respectively allocated for output and input of information. The input window 151b may be displayed with a soft key 151c indicated with numbers for input of telephone numbers and the like.

In a case the soft key 151c is touched, numbers corresponding to the touched soft key may be displayed on the output window 151a. In a case a first manipulating unit 131 is manipulated, a call connection is attempted to a telephone number displayed on the output window 151a.

FIG. 3b illustrates an input of touch applied to a soft key through a rear surface of body of the mobile terminal (terminal body). FIG. 3a illustrates the terminal body arranged in a longitudinal way (portrait) while FIG. 3b illustrates the terminal body (landscape) arranged in a crosswise way. The display 151 may be configured to change an output screen according to arrangement direction of the terminal body.

FIG. 3b illustrates a text input mode being operated in a mobile terminal. The display 151 is displayed with an output window 151a′ and an input window 151b′. The input window 151b′ may be arranged with a plurality of soft keys 151c′ displayed with at least one of a text, a symbol and numbers. The plurality of soft keys 151c′ may be arranged in the form of QWERTY keys.

In a case the soft keys 151c′ are touched via the touch pad (135. see FIG. 2b), text, numbers and symbol corresponding to the touched soft key are displayed on the output window 151a′. As noted above, there is an advantage in the touch input via the touch pad 135 over the touch input via the display 151 in that the soft key 151c′ is not hidden by a finger during touch.

In a case the display 151 and the touch pad 135 are transparently formed, fingers positioned at a rear surface of the terminal body can be checked visually, thereby enabling to provide a more accurate touch input.

In addition to the input methods thus disclosed by the exemplary embodiments, the display 151 or the touch pad 135 may be configured to receive the touch via scroll. The user can scroll the display 151 or the touch pad 135 to move a subject displayed on the display 151, e.g., a cursor or a pointer positioned on an icon. Furthermore, in a case a finger is moved on the display 151 or the touch pad 135, a path along which the finger has moved can be visually displayed on the display 151, which may be very useful in editing an image displayed on the display 151.

To cope with a case where the display 151 and the touch pad 135 are simultaneously touched within a predetermined time scope, a function of the terminal may be executed. The case where the display 151 and the touch pad 135 are simultaneously touched within a predetermined time scope may be a case where a thumb and a first finger of the user are used to clamp the terminal body. The one function may be, for example, activation or inactivation of the display 151 or the touch pad 135.

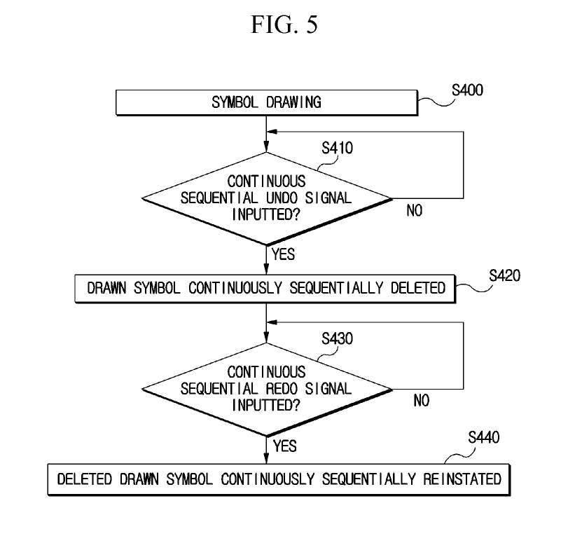

Now, a method for editing data in mobile terminal according to an exemplary embodiment of the present disclosure will be described in detail with reference to FIG. 4 and FIG. 5.

### First Exemplary Embodiment

FIG. 4 is a flowchart illustrating a method for editing data in a mobile terminal according to a first exemplary embodiment of the present disclosure.

Referring to FIG. 4, a user may input a symbol on the touch screen (S1000), where the symbol may include a text, a number, a sign and a graphic. At this time, the user may input the symbol by touching the keypad, the soft key or the touch screen.

The user may continuously and sequentially input an undo signal relative to the symbol using the touch screen (S1010). The controller 180 may delete the symbol responsive to the inputted continuous and sequential undo signal (S1020). At this time, the deleted symbol may be temporarily stored in the memory 160. The continuous and sequential undo signal is a signal configured to delete the inputted symbol continuously and sequentially.

In a case the deleted symbol is desired to be reinstated, the user may use the touch screen to input a continuous and sequential redo signal to the controller 180 (S1030). The controller 180 may reinstate the deleted symbol in response to the inputted continuous and sequential redo signal (S1040), where the continuous and sequential redo signal means a signal configured to reinstate the deleted signal continuously and sequentially.

According to the present disclosure, the user may conveniently delete or reinstate a desired portion out of symbols inputted by the user.

### Second Exemplary Embodiment

FIG. 5 is a flowchart illustrating a method for editing data in a mobile terminal according to a second exemplary embodiment of the present disclosure.

Referring to FIG. 5, a user may use the touch screen to draw a symbol (S400), where the symbol may correspond to a text, a number, a sign and a graphic.

In a case the symbol is desirous of being edited, the user may use the touch screen to continuously and sequentially input an undo signal to the controller 180 (S410). The controller 180 may delete the drawn symbol responsive to the inputted continuous and sequential undo signal (S420). At this time, the continuous and sequential undo signal is a signal configured to delete the drawn symbol continuously and sequentially.

In a case the deleted symbol is desired to be reinstated, the user may use the touch screen to input a continuous and sequential redo signal to the controller 180 (S430). The controller 180 may reinstate the drawn symbol in response to the inputted continuous and sequential redo signal (S440), where the continuous and sequential redo signal means a signal configured to reinstate the deleted signal continuously and sequentially.

According to the exemplary embodiment of a method for generating an undo signal or a redo signal continuously and sequentially, the controller 180 may display a wheel-shaped input medium on the display 151. The wheel-shaped input medium is configured to generate the undo signal or the redo signal continuously and sequentially. The user may generate the undo signal or the redo signal continuously and sequentially by touching and dragging the wheel-shaped input medium.

To be more specific, the user may generate the undo signal or the redo signal continuously and sequentially by touching and dragging the wheel-shaped input medium clockwise or counterclockwise.

According to another exemplary embodiment of a method for generating an undo signal or a redo signal continuously and sequentially, the user may input a gesture input to the touch screen to generate the undo signal or the redo signal continuously and sequentially. The gesture input means a pattern such as a circle, a straight line and a zigzag shape inputted by the user using the touch screen.

According to the present disclosure, the user may conveniently delete or reinstate a desired portion out of symbols inputted by the user.

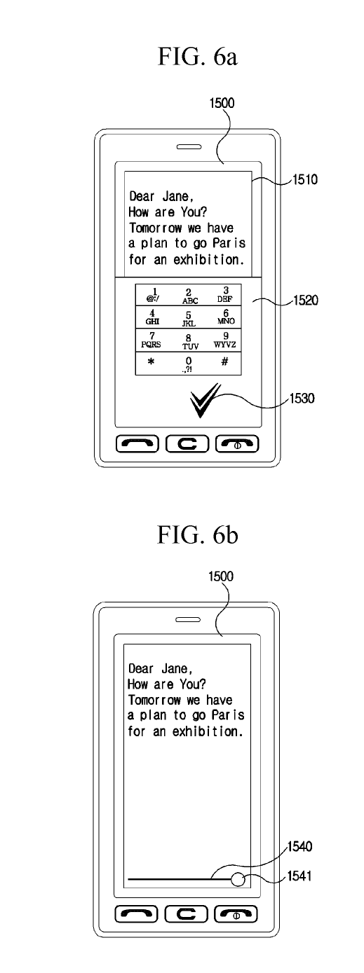

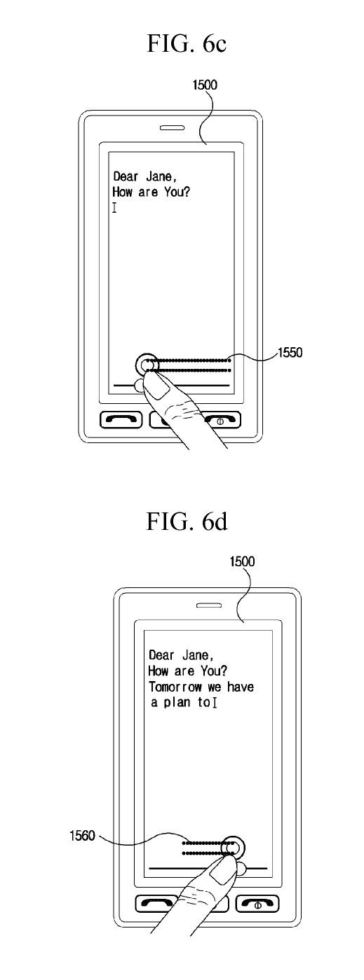

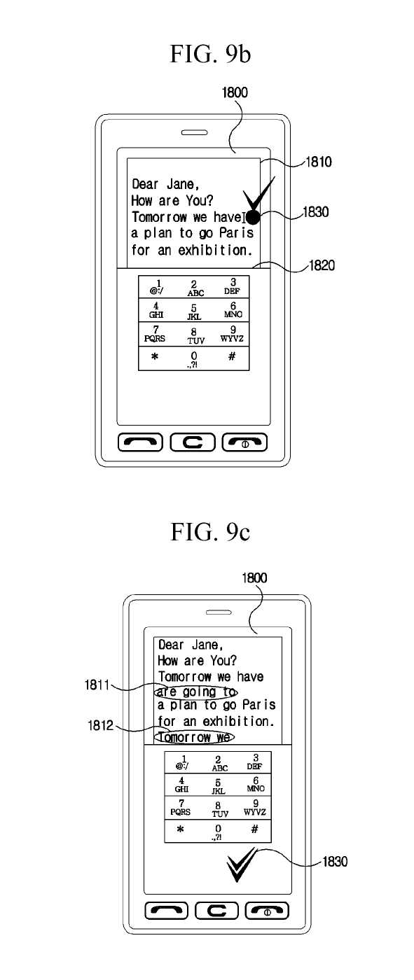

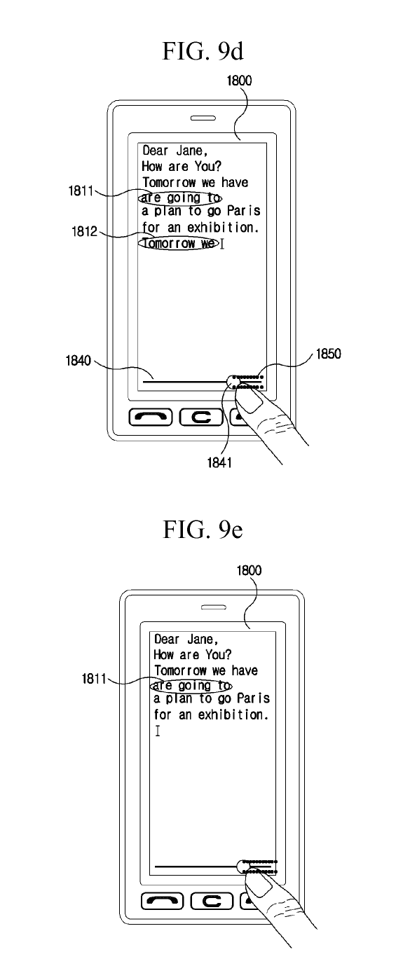

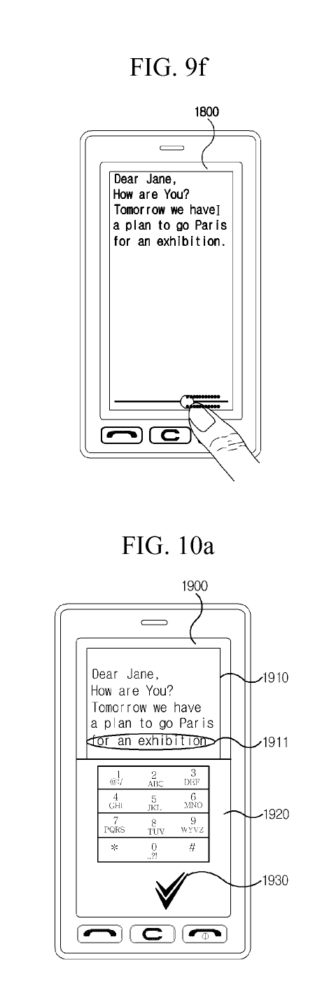

Now, a method for editing data in mobile terminal according to examples of an exemplary embodiment of the present disclosure will be described in detail with reference to FIGS. 6 and 9.

### First Example

FIG. 6a˜6d are an image view illustrating a first example of a method for editing data in a mobile terminal according to a first exemplary embodiment of the present disclosure.

FIG. 6a illustrates a symbol display screen 1500 that includes an output window 1510 and a soft key 1520.

A user may use the soft key 1520 to input a symbol (a text) on the touch screen. Next, in a case the user uses a pointing device to input a progress bar display signal 1530 on the touch screen, the controller 180 may display a progress bar 1540 including a handler 1541 on the touch screen (see FIG. 6b), where the progress bar may be displayed based on the quantity of inputted data.

The progress bar display signal 1530 may be generated by a touch signal relative to the touch screen. However, the progress bar display signal 1530 is not limited thereto. The progress bar display signal 1530 can be generated by an hot key (namely, exclusive key or private key) or by a motion sensor (not shown) configured to sense the motion of the user.

The user may use the pointing device to drag (undo signal.1550) the touch screen to the left hand side. Then, the controller 180 may continuously and sequentially delete the inputted data. Furthermore, the controller 180 may move the position of the handler 1541 based on the amount of deleted data (see FIG. 6c).

Alternatively, the user may use the pointing device to drag (redo signal.1560) the touch screen to the right hand side. Then, the controller 180 may continuously and sequentially reinstate the deleted data. Furthermore, the controller 180 may move the position of the handler 1541 based on the amount of deleted data (see FIG. 6d).

According to the present disclosure, the user may conveniently delete or reinstate a desired portion out of symbols inputted by the user.

### Second Example

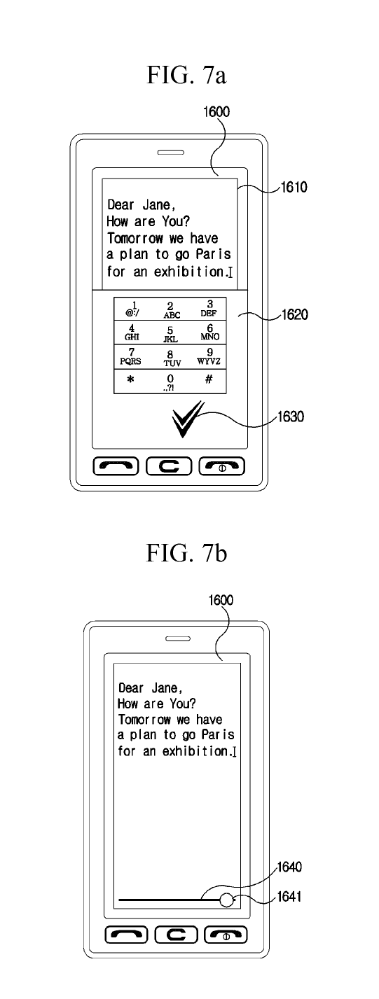

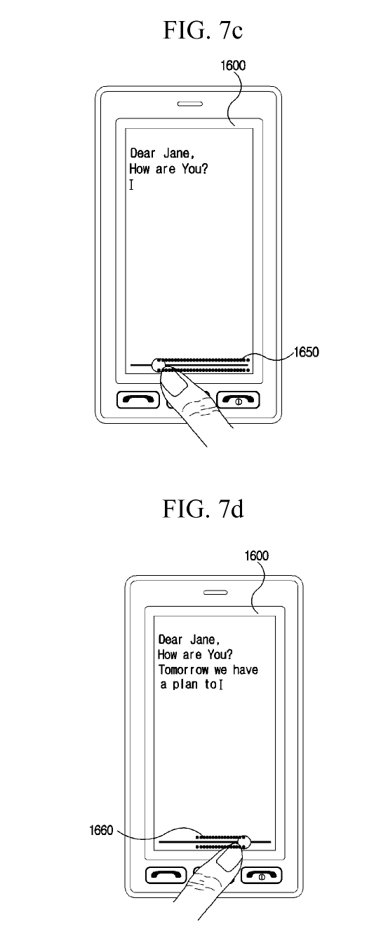

FIG. 7a˜7d are an image view illustrating a second example of a method for editing data in a mobile terminal according to the first exemplary embodiment of the present disclosure.

FIG. 7a illustrates a symbol display screen 1600 that includes an output window 1610 and a soft key 1620.

A user may use the soft key 1620 to input a symbol (a text) on the touch screen. Next, in a case the user uses a pointing device to input a progress bar display signal 1630 on the touch screen, the controller 180 may display a progress bar 1640 including a handler 1641 on the touch screen (see FIG. 7b).

The user may touch and drag (undo signal 1650) the handler 1641 to the left hand side. Then, the controller 180 may continuously and sequentially delete the inputted data (see FIG. 7c).

Alternatively, the user may touch and drag (redo signal 1660) the handler 1641 to the right hand side. Then, the controller 180 may continuously and sequentially reinstate the deleted data (see FIG. 7d), where the controller 180 bases the position of the symbol for deletion or reinstatement of the symbol. That is, the controller 180 may delete the symbol positioned at the front from a current position of the cursor, or reinstate the symbol positioned at the back from the current position of the cursor.

According to the present disclosure, the user may conveniently delete or reinstate a desired portion out of symbols inputted by the user.

### Third Example

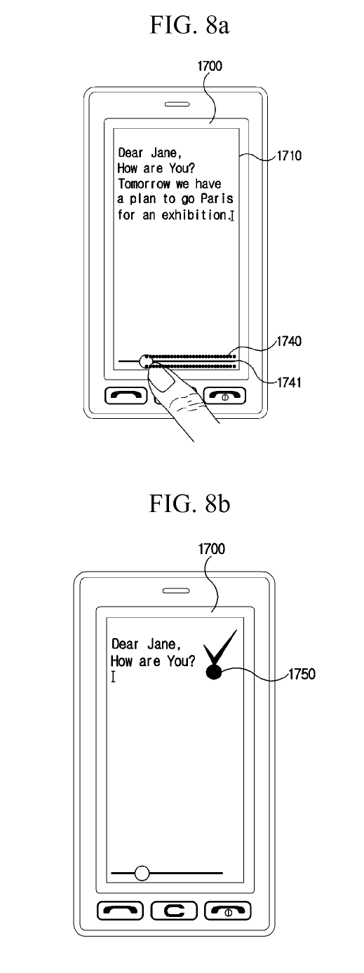

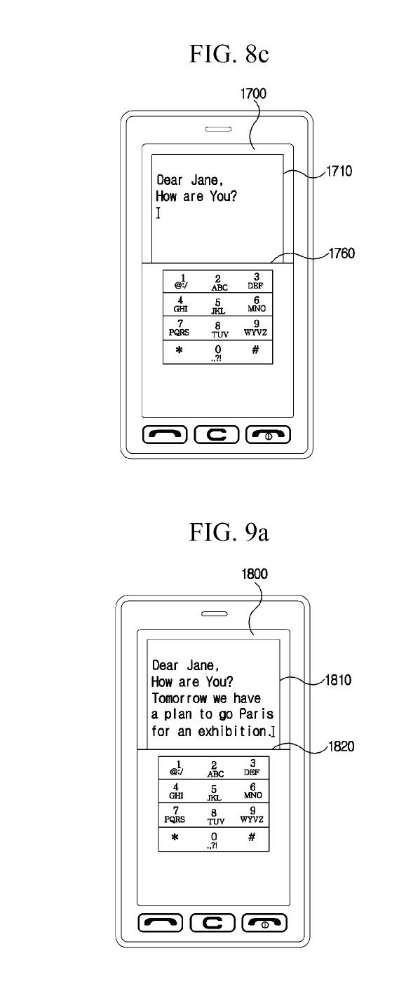

FIG. 8a˜8c are an image view illustrating a third example of a method for editing data in a mobile terminal according to the first exemplary embodiment of the present disclosure.

FIG. 8a illustrates a symbol display screen 1700 that includes an output window 1710 and a handler 1741.

A user may delete or reinstate the data by touching and dragging the handler 1741. Next, in a case the user inputs a symbol input mode entry signal 1750 to enter a symbol input mode, the controller 180 may delete the display of the progress bar 1740 and display the symbol display screen 1700 including a soft key 1760 on the touch screen (see FIGS. 8b and 8c). Therefore, the user may conveniently enter the symbol input mode after deleting or reinstating the symbol.

According to the present disclosure, the user may conveniently delete or reinstate a desired portion out of symbols inputted by the user.

### Fourth Example

FIG. 9a˜9f is an image view illustrating a fourth example of a method for editing data in a mobile terminal according to the first exemplary embodiment of the present disclosure.

FIG. 9a illustrates a symbol display screen 1800 that includes an output window 1810 and a soft key 1820.

A user may use the soft key 1820 to input a symbol (a text) on the touch screen. Next, in a case the user inputs a position change signal 1830 to change the position of the cursor, the controller 180 may change the position of the cursor. Successively, the user inputs a first text 1811 (see FIGS. 9b and 9c).

Next, the user moves the position of the cursor to the extreme end of the text, and inputs a second text 1812.

Thereafter, in a case the user uses the pointing device to input a progress bar display signal 1830 on the touch screen, the controller 180 may display a progress bar 1840 including the handler 1841 on the touch screen (see FIG. 9d).

The user may touch and drag (undo signal 1850) the handler 1841 to the left hand side. Then, the controller 180 may continuously and sequentially delete the second text (see FIG. 9e). Next, in a case the undo signal keeps incoming, the controller 180 may continuously and sequentially delete the first text (see FIG. 9f). That is, the controller 180 deletes or reinstate the texts based on the time sequence of inputted texts.

According to the present disclosure, the user may conveniently delete or reinstate a desired portion out of symbols inputted by the user.

### Fifth Example

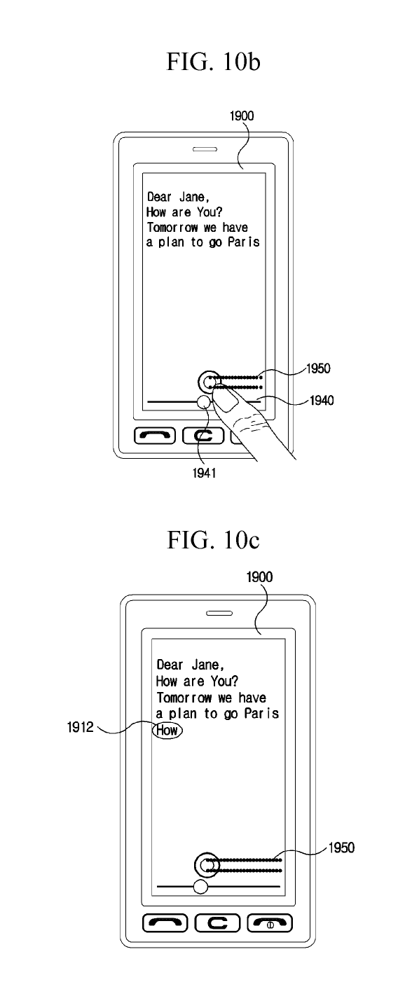

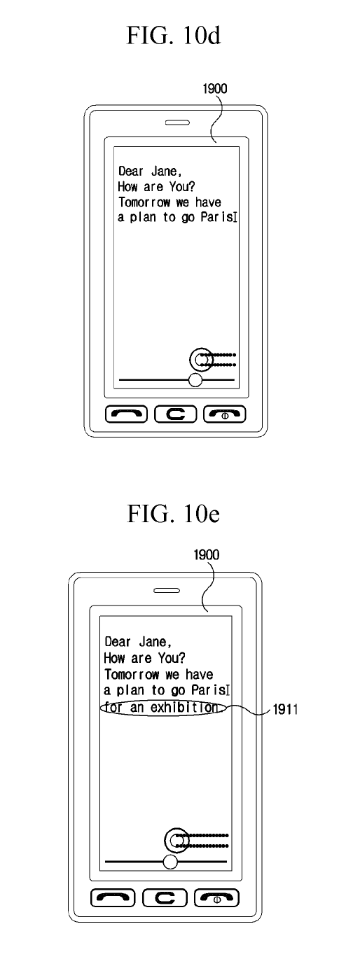

FIG. 10a˜10e are an image view illustrating a fifth example of a method for editing data in a mobile terminal according to the first exemplary embodiment of the present disclosure.

FIG. 10a illustrates a symbol display screen 1900 that includes an output window 1910 and a soft key 1920. The user may use the soft key 1920 to input a first text 1911 on the touch screen. Next, in a case the user uses the pointing device to input a progress bar display signal 1930 on the touch screen, the controller 180 may display a progress bar 1940 including a handler 1941 on the touch screen (see FIG. 10b).

The user may touch and drag (undo signal 1950) the handler 1941 to the left hand side. Then, the controller 180 may continuously and sequentially delete the first text 1911 in response to the undo signal (see FIG. 10b). Next, the user may input the second text 1912 through the soft key, and touch and drag (undo signal 1950) the handler 1941 to the left hand side (see FIG. 10c). Then, the controller 180 may continuously and sequentially delete the second text 1912 (see FIG. 10d).

Successively, in a case the undo signal is inputted, the controller 180 may extract all the first texts 1911 from the memory 160 and display the first texts 1911 on the touch screen. As a result, all the data that have been deleted at one time can be reinstated (see FIG. 10e).

According to the present disclosure, the user may conveniently delete or reinstate a desired portion out of symbols inputted by the user.

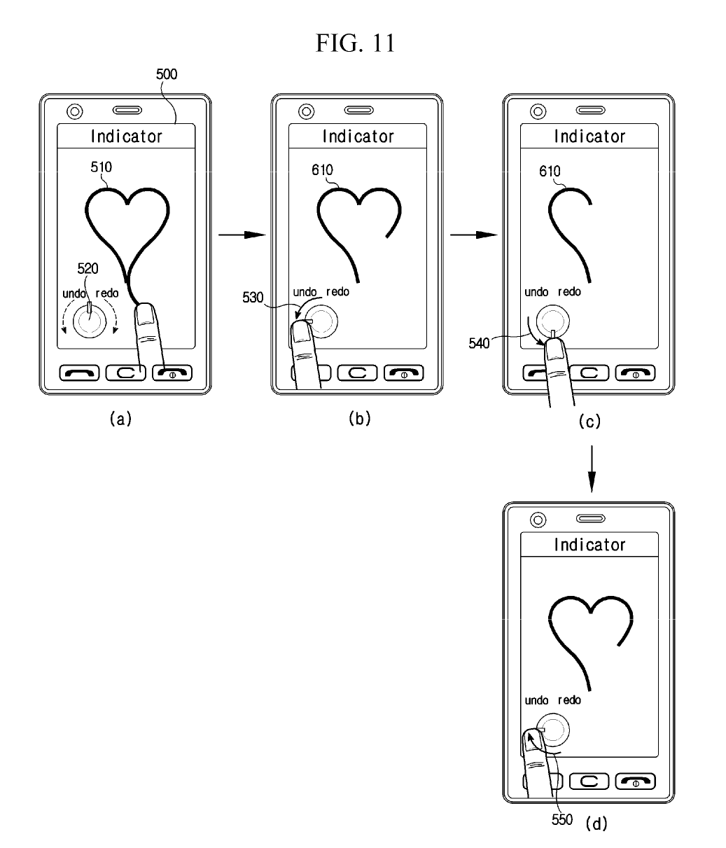

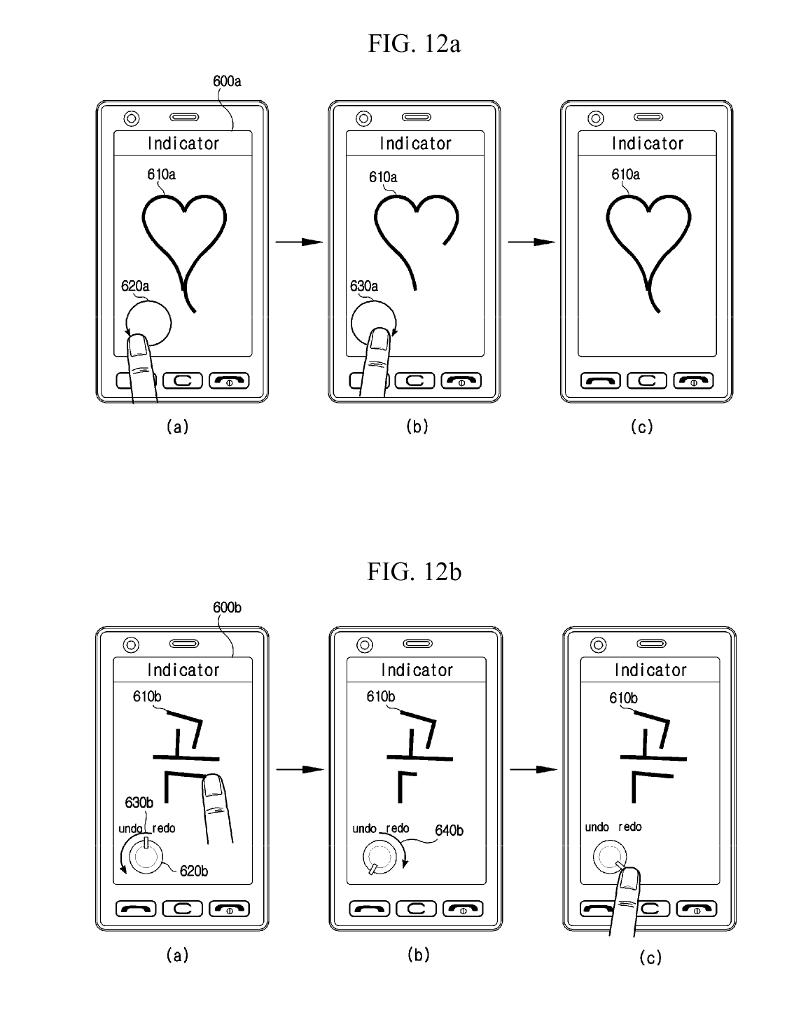

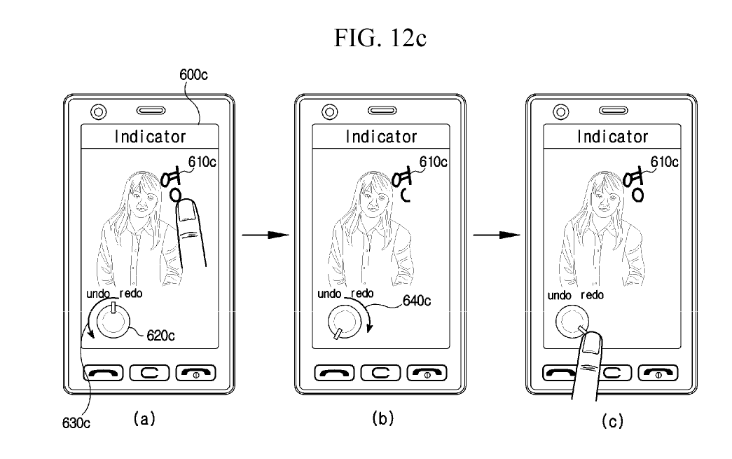

Now, a method for editing data in mobile terminal according to examples of the second exemplary embodiment of the present disclosure will be described in detail with reference to FIGS. 11 and 12.

### First Example

FIG. 11 is an image view illustrating a first example of a method for editing data in a mobile terminal according to the second exemplary embodiment of the present disclosure.

FIG. 11 (a) is an image view illustrating a screen 500 where the user has drawn a symbol 510 using the touch screen. The screen 500 includes the symbol and a wheel-shaped input medium 520.

If the symbol is to be edited, the user may touch and drag the wheel-shaped input medium 520 counterclockwise, whereby the undo signal may be continuously and sequentially inputted to the controller 180. The controller 180 may continuously and sequentially delete the symbol 510 in response to the undo signal that has been inputted continuously and sequentially (see FIG. 11 (b)).

The controller may delete more portions of the symbols 510 in FIG. 11 (c) than in FIG. 11 (b) by touching and dragging the wheel-shaped input medium 520 counterclockwise (see FIG. 11 (c)). That is, the controller 180 may also control the degree of deletion of symbol 510 according to the degree of the continuous and sequential undo signal.

In a case the deleted symbol is to be reinstated, the user touches and drags 550 the wheel-shaped input medium 520 clockwise and inputs the continuous and sequential redo signal to the controller 180. The controller 180 may continuously and sequentially reinstate the drawn symbol in response to the redo signal inputted continuously and sequentially (see FIG. 11 (d)). A method for the user to generate the continuous and sequential undo or redo signal may be variable. For example, the keypad may be used, various shapes of input media may be used or a multiple touch may be used.

FIGS. 12a, 12b and 12c are image views illustrating second examples of a method for editing symbols according to the second exemplary embodiment of the present disclosure.

FIG. 12a is an image view of a first modification.

FIG. 12a is an image view illustrating a screen 600a where the user has drawn a symbol 610a using the touch screen.

In a case the symbol 610a is to be edited, the user may input a counterclockwise gesture to a space not displayed with an image or an icon in the touch screen 620a, and input the continuous and sequential undo signal to the controller 180 {see FIG. 12a (a)}. The controller 180 may continuously and sequentially delete the symbol 610a responsive to the inputted continuous and sequential undo signal {see FIG. 12a (b)}.

In a case the deleted symbol is to be reinstated, the user may input a clockwise gesture 630a and input the clockwise gesture 630a and input continuous and sequential redo signal to the controller 180. The controller 180 may continuously and sequentially reinstate the drawn symbol responsive to the inputted continuous and sequential redo signal {see FIG. 12a (c)}.

FIG. 12b is an image view of a second modification.

FIG. 12b is an image view illustrating a screen 600b where the user has drawn a symbol 610b using the touch screen. The symbol may be a text as illustrated in the figure.

In a case the symbol 610b is to be edited, the user may touch and drag the wheel-shaped input medium 630b counterclockwise, and input the continuous and sequential undo signal to the controller 180 {see FIG. 12b (a)}. The controller 180 may continuously and sequentially delete the symbol 610b responsive to the inputted continuous and sequential undo signal {see FIG. 12b (b)}. That is, a portion of the text is deleted.

In a case the deleted symbol is to be reinstated, the user may touch and drag the wheel-shaped input medium 620b counterclockwise 640b, and input the continuous and sequential redo signal to the controller 180. The controller 180 may continuously and sequentially reinstate the drawn symbol responsive to the inputted continuous and sequential redo signal {see FIG. 12b (c)}.

FIG. 12c is an image view of a third modification.

FIG. 12c is an image view illustrating a screen 600c where the user has drawn a symbol 610c using the touch screen. The symbol may be a text to be inserted into a predetermined image or a moving picture, as illustrated in the figure.

For example, the user may use a particular menu or button to display an image or a moving picture on the display 151. The user may insert a text or a symbol into the displayed image or moving picture using the touch screen.

In a case the symbol 610c is to be edited, the user may touch and drag the wheel-shaped input medium 620c counterclockwise 630c, and input the continuous and sequential undo signal to the controller 180 {see FIG. 12c (a)}. The controller 180 may continuously and sequentially delete the symbol 610c responsive to the inputted continuous and sequential undo signal {see FIG. 12c (b)}. That is, a portion of the text is deleted.

In a case the deleted symbol is to be reinstated, the user may touch and drag the wheel-shaped input medium 620c counterclockwise 640c, and input the continuous and sequential redo signal to the controller 180. The controller 180 may continuously and sequentially reinstate the drawn symbol responsive to the inputted continuous and sequential redo signal {see FIG. 12c (c)}.

The above-mentioned method for editing data in mobile terminal and mobile terminal using the same may, however, be embodied in many different forms and should not be construed as limited to the embodiments set forth herein. While particular features or aspects may have been disclosed with respect to several embodiments, such features or aspects may be selectively combined with one or more other features and/or aspects of other embodiments as may be desired.

Although the present disclosure has been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of editing data in a mobile terminal, the method comprising:
displaying the data on a display module of the mobile terminal;
displaying a user input unit to manipulate the displayed data when a display signal is detected, wherein the user input unit corresponds to a specific amount of displayed data;
generating a first signal to delete at least a portion of the displayed data when the user input unit is manipulated in a first direction; and
generating a second signal to reinstate the deleted at least a portion of the displayed data when the user input unit is manipulated in a second direction.

2. The method of claim 1, wherein the user input unit is a progress bar including a handler.

3. The method of claim 2, wherein the progress bar is manipulated in a linear direction using the handler.

4. The method of claim 2, wherein the progress bar is manipulated in a circular direction using the handler.

5. The method of claim 2, wherein the progress bar is manipulated in a zigzag direction using the handler.

6. The method of claim 1, wherein the deleted at least a portion of displayed data is stored in a memory unit of the mobile terminal.

7. The method of claim 1, wherein the first signal is configured to delete the at least a portion of the displayed data sequentially.

8. The method of claim 1, wherein the second signal is configured to reinstate the deleted at least a portion of the displayed data sequentially.

9. A method of editing data in a mobile terminal, the method comprising:
displaying the data received from a user input unit on a touch screen of the mobile terminal;
displaying a progress bar including a handler on the touch screen when a progress bar display signal is detected;
generating an undo signal to delete a specific portion of the displayed data in response to manipulation of the handler in a first direction; and
generating a redo signal to reinstate the deleted specific portion of the displayed data in response to manipulation of the handler in a second direction.

10. The method of claim 9, wherein the displayed data comprises characters, figures or symbols input by a keypad or a soft key.

11. The method of claim 9, wherein the undo signal is a sequential signal generated by a touch and drag input using the handler in a leftward direction.

12. The method of claim 9, wherein the redo signal is a sequential signal generated by a touch and drag input using the handler in a rightward direction.

13. The method of claim 9, wherein the undo signal is a sequential signal generated by a touch and drag input using the handler in a counterclockwise direction.

14. The method of claim 9, wherein the redo signal is a sequential signal generated by a touch and drag input using the handler in a clockwise direction.

15. The method of claim 9, further comprising:
sequentially deleting the specific portion of the displayed data in response to the undo signal sequentially generated according to a displaced distance of the handler in relation to the progress bar.

16. The method of claim 9, further comprising:
sequentially reinstating the deleted specific portion of the displayed data in response to the redo signal sequentially generated according to a displaced distance of the handler in relation to the progress bar.

17. The method of claim 9, further comprising:
removing the displayed progress bar; and
changing a current mode of the mobile terminal to a data input mode configured to receive additional data if a data input mode entry signal is detected.

18. The method of claim 9, further comprising:
deleting the specific portion of the displayed data based on a data input time sequence or a data position sequence in response to the generated undo signal.

19. The method of claim 9, further comprising:
reinstating the deleted specific portion of the displayed data based on a data input time sequence or a data position sequence in response to the generated redo signal.

20. A mobile terminal, comprising:
a touch screen configured to display data; and
a controller configured to display a progress bar including a handler on the touch screen when a progress bar display signal is detected, and sequentially delete the displayed data when an undo signal is sequentially generated, or sequentially reinstate the deleted displayed data when a redo signal is sequentially generated.

21. A method of editing data in a mobile terminal, the method comprising:
receiving data relating to a drawing on a touch screen;
displaying the received data on the touch screen;
generating a sequential undo signal to manipulate the displayed data; and
sequentially deleting the displayed data in response to the sequential undo signal.

22. The method of claim 21, further comprising:
generating a sequential redo signal to manipulate the deleted data; and
sequentially reinstating the deleted data in response to the sequential redo signal.

23. The method of claim 22, further comprising:
displaying a wheel-shaped input media on the touch screen; and
generating the sequential undo or redo signal in response to touching and dragging the wheel-shaped input media.

24. The method of claim 22, further comprising:
generating the sequential undo or redo signal in response to a gesture input on the touch screen.

25. A mobile terminal for editing data, the mobile terminal comprising:
a touch screen configured to display a drawing related to data received from a user input unit; and
a controller configured to sequentially delete or reinstate the displayed drawing in response to a sequentially generated undo or redo signal when the drawing is displayed on the touch screen.

26. The mobile terminal of claim 25, wherein the sequentially generated undo or redo signal is generated when a wheel-shaped input media displayed on the touch screen is touched and dragged in a specific direction.

27. The mobile terminal of claim 25, wherein the sequentially generated undo or redo signal is generated in response to a gesture input provided on the touch screen.
